(19) United States
(12) Patent Application Publication
(10) Pub. No.: US 2025/0298562 A1
(43) Pub. Date: Sep. 25, 2025

(54) PRINTING SYSTEM

(71) Applicant: FUJIFILM Business Innovation Corp., Tokyo (JP)

(72) Inventors: Yuki ANDO, Kanagawa (JP); Naohiro TATEISHI, Kanagawa (JP); Tetsuhiro INOUE, Kanagawa (JP)

(73) Assignee: FUJIFILM Business Innovation Corp., Tokyo (JP)

(21) Appl. No.: 18/820,293

(22) Filed: Aug. 30, 2024

(30) Foreign Application Priority Data
Mar. 25, 2024 (JP) 2024-047785

(51) Int. Cl. G06F 3/12

(52) U.S. Cl. CPC G06F 3/125; G06F 3/1208

(57) ABSTRACT

A printing system includes a printing unit that prints a print job and prints a position adjustment image corresponding to each page in the print job, a reading unit that reads the position adjustment image printed by the printing unit, and an adjustment unit that adjusts a printing position of each page in the print job to be printed by the printing unit on the basis of the position adjustment image read by the reading unit, and adjusts printing positions of a minimum number of pages for which printing positions are adjustable, among second and subsequent pages in the print job, on the basis of a position adjustment image of a first page in the print job.

### CROSS-REFERENCE TO RELATED APPLICATIONS

This application is based on and claims priority under 35 USC 119 from Japanese Patent Application No. 2024-047785 filed Mar. 25, 2024.

### BACKGROUND

### (i) Technical Field

The present invention relates to a printing system.

### (ii) Related Art

JP2018-010115A discloses an image forming apparatus including a print image forming unit that forms an image and prints the image on a transfer medium, and a control unit that manages a job and controls image formation in the image forming unit, wherein the control unit has a real-time adjustment function of acquiring a reading result of an adjustment image by printing the adjustment image on the transfer medium during job output of printing the image on the transfer medium on the basis of the job by the image forming unit, and performing adjustment of the image quality of the image formed by the image forming unit on the basis of the reading result in real time, and in a case where a job of not performing the real-time adjustment and a job of performing the real-time adjustment are continuous in an execution job, the control unit acquires a reading result by printing the adjustment image on the transfer medium in the job of not performing the real-time adjustment, and applies the image quality adjustment to the job of performing the real-time adjustment on the basis of the reading result.

### SUMMARY

Aspects of non-limiting embodiments of the present disclosure relate to a printing system that enables the number of pages in which the printing position is not adjusted to be reduced, as compared with a case where the printing position of a page in a print job is adjusted on the basis of position adjustment images of a plurality of pages in the print job.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a printing system including: a printing unit that prints a print job and prints a position adjustment image corresponding to each page in the print job; a reading unit that reads the position adjustment image printed by the printing unit; and an adjustment unit that adjusts a printing position of each page in the print job to be printed by the printing unit on the basis of the position adjustment image read by the reading unit, and adjusts printing positions of a minimum number of pages for which printing positions are adjustable, among second and subsequent pages in the print job, on the basis of a position adjustment image of a first page in the print job.

### BRIEF DESCRIPTION OF THE DRAWINGS

Exemplary embodiment(s) of the present invention will be described in detail based on the following figures, wherein:

FIG. 1 is a diagram showing a schematic configuration of a printing system according to an exemplary embodiment;

FIG. 2 is a plan view showing a printed material on which a position adjustment image according to the exemplary embodiment is printed;

FIG. 3 is an explanatory diagram illustrating the operation of the printing system that starts printing a subsequent printed material before reading the position adjustment image from a printed material of a first page;

FIG. 4 is a graph indicating the relationship between the number of printed sheets of a printed material and the misalignment amount of a position adjustment image M read from the printed material by an image reader in the printing system shown in FIG. 3;

FIG. 5 is an explanatory diagram illustrating the operation of the printing system that calculates a moving average value of a plurality of pieces of misalignment information and calculates a correction value for the printing position of a print image on the basis of the calculated moving average value;

FIG. 6 is a graph indicating the relationship between the number of printed sheets of a printed material and the misalignment amount of a read image read from the printed material by an image reader in the printing system shown in FIG. 5;

FIG. 7 is a block diagram showing the hardware configuration of the printing system shown in FIG. 1;

FIG. 8 is a functional block diagram of the printing system shown in FIG. 1;

FIG. 9 is a flowchart showing the flow of a printing position adjustment process in the printing system shown in FIG. 1;

FIG. 10 is an explanatory diagram illustrating the feedback control of the printing position of a print image to be printed on paper in the printing system shown in FIG. 1;

FIG. 11 is a graph indicating the relationship between the number of printed sheets of a printed material and the misalignment amount or the correction value;

FIG. 12 is a graph indicating the relationship between the number of printed sheets of a printed material and the misalignment amount or the correction value; and

FIG. 13 is a graph indicating the relationship between the number of printed sheets of a printed material and the misalignment amount.

### DETAILED DESCRIPTION

Hereinafter, an exemplary embodiment will be described with reference to the drawings.

### Overview of Printing Device

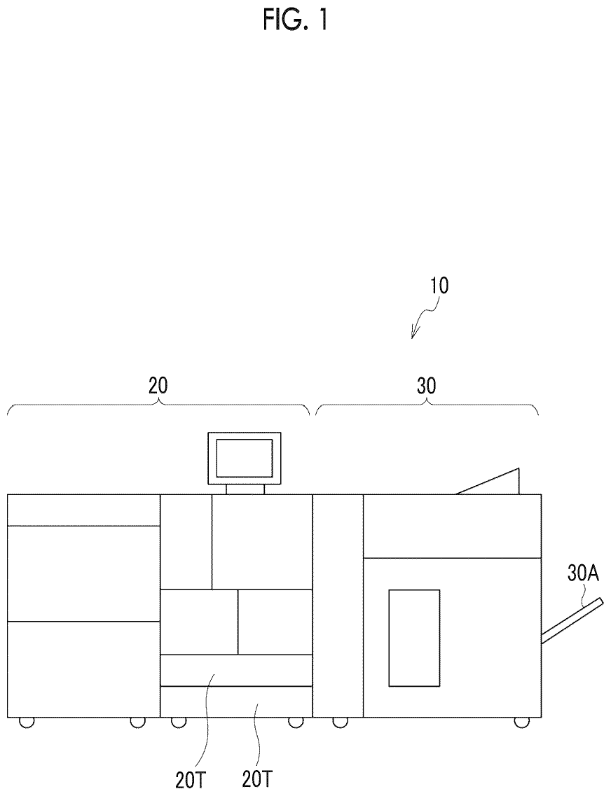

FIG. 1 shows a printing system 10 according to an exemplary embodiment. The printing system 10 includes a printer 20 and an image reader 30.

### Printer

The printer 20 includes a plurality of accommodation trays 20T that accommodate paper. In addition, the printer 20 has a printing function of printing an image (hereinafter referred to as a “print image”) on the paper supplied from the accommodation trays 20T. The printer 20 supplies the paper on which a print image is printed (hereinafter referred to as “printed material”) to the image reader 30. The paper is an example of a recording medium.

### Image Reader

The image reader 30 has an image reading function of sequentially receiving the printed material on which a print image is printed from the printer 20 and reading the print image from the received printed material. Specifically, the image reader 30 includes a scanner or the like as an inline sensor that optically reads the print image from the printed material received from the printer 20. In addition, the image reader 30 includes an output tray 30A that discharges printed material from which a print image is read.

### Printing Position Adjustment Function

The printing system 10 includes a printing position adjustment function of adjusting the position of a print image to be printed on paper. In the printing process for executing this printing position adjustment function, a print image for detecting the printing position of the print image printed on the paper (hereinafter referred to as a “position adjustment image”) is printed on paper. The position adjustment image is printed, for example, in the margin region of the paper to be cut.

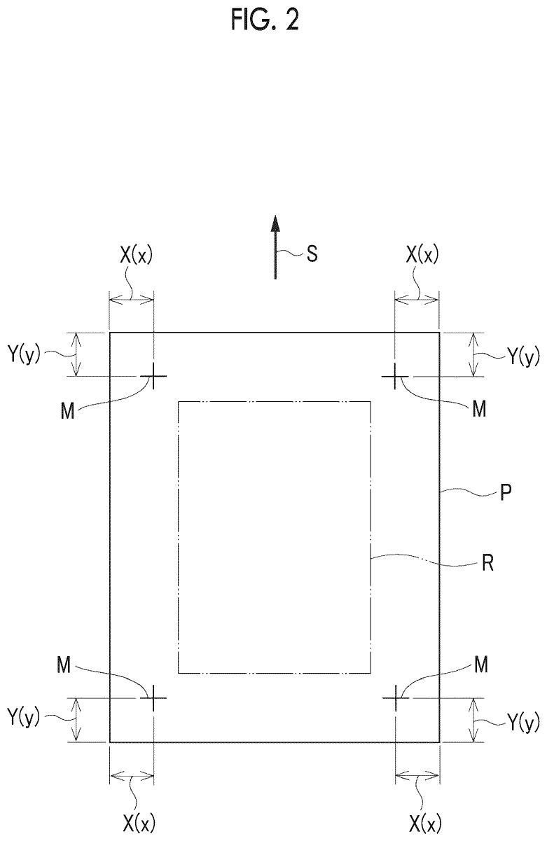

FIG. 2 shows an example of a position adjustment image M. As an example, the position adjustment image M is a cross-shaped image and is printed in each of the four corners of the margin region outside the image printing region R on paper P. In addition, each position adjustment image M is printed such that the position adjustment image M is disposed at a predetermined position (hereinafter referred to as a “target position”) on the paper P. Examples of the target position of the position adjustment image M include a predetermined distance (hereinafter referred to as “target distances X and Y”) from the outer peripheral edge of the paper P.

In two-sided printing where print images are printed on both sides of the paper P, a plurality of position adjustment images M are respectively printed on both sides of the paper P.

Each position adjustment image M printed on the paper P is read by the image reader 30. Then, the position adjustment image M read by the image reader 30 is subjected to image analysis, and the position of the position adjustment image M on the paper P (hereinafter referred to as the “detection position”) is detected. Examples of the detection position of the position adjustment image M on the paper P include the distance from the outer peripheral edge of the paper P to the position adjustment image M (hereinafter referred to as “detection distances x, y”). The misalignment information of the position adjustment image M is calculated on the basis of the detection position and the above-described target position.

Examples of the misalignment information include the lead position, the side position, the right angle correction amount, the trapezoidal correction amount, the horizontal magnification (main scanning magnification), and the vertical magnification (sub-scanning magnification). As an example, the lead position is the misalignment amount of the position adjustment image M in the transport direction of the paper P, and is calculated, for example, as the difference (X−x) between the target distance X and the detection distance x. In addition, the side position is the misalignment amount of the position adjustment image M in a direction orthogonal to the transport direction of the paper P, and is calculated, for example, as the difference (Y−y) between the target distance Y and the detection distance y.

Next, a correction value for adjusting the printing position of the print image to be printed on the paper P is calculated on the basis of the calculated misalignment information. As an example, the correction value is calculated for each type of misalignment information (lead position, side position, right angle correction amount, trapezoidal correction amount, horizontal magnification, and vertical magnification) described above.

For example, the correction value for the lead position is calculated as position information indicating the printing start position of the print image with the leading edge of the paper P in the transport direction as a reference. In addition, for example, the correction value for the side position is calculated as position information indicating the printing start position of the print image with one end of the paper P in the direction orthogonal to the transport direction as a reference. Then, the printing position of the print image to be printed on the paper P is adjusted in the printer 20 on the basis of the calculated correction value.

### Correction Continuous Printing Function

Here, in the printing system 10, in a case where a plurality of printed materials are continuously printed, the misalignment of the printing position of the print image is likely to occur due to the influence of the temperature rise of the transport mechanism for transporting the paper, and the misalignment amount of the printing position of the print image is likely to change in accordance with the temperature of the transport mechanism. Therefore, the printing system 10 according to the present exemplary embodiment includes a correction continuous printing function (real-time correction continuous printing function) for adjusting the position of a print image to be printed on paper while continuously printing a plurality of printed materials.

In a print job using the correction continuous printing function, while a plurality of printed materials are continuously printed, the printing position of a print image is adjusted via feedback control on the basis of a position adjustment image printed on a preceding printed material.

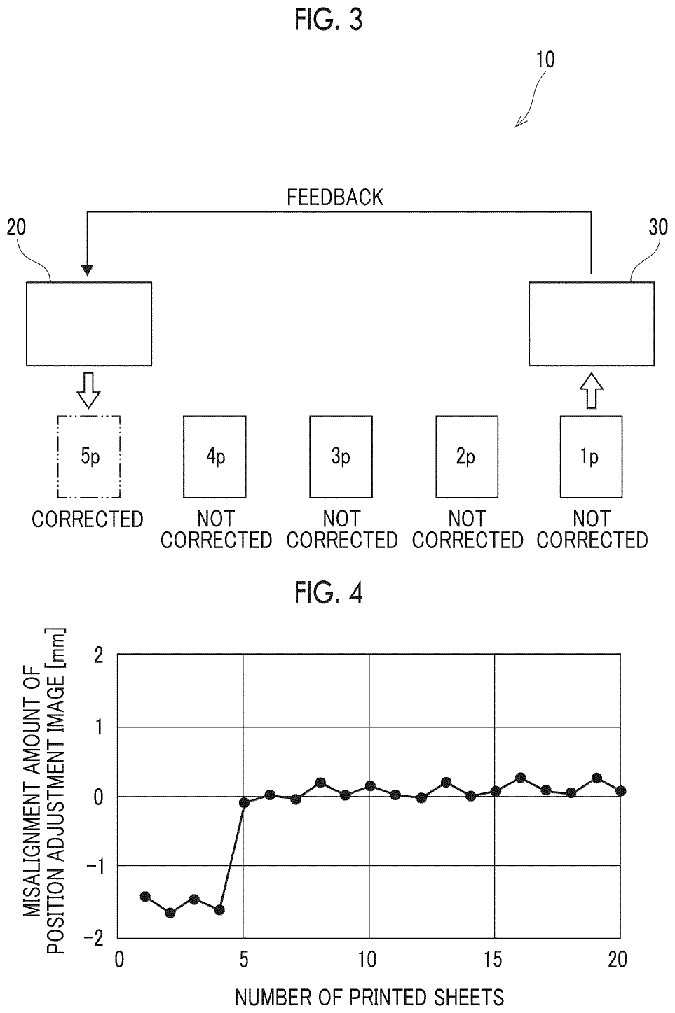

Specifically, as shown in the schematic diagram shown in FIG. 3, the printing system 10 prints the position adjustment image (refer to FIG. 2) in the margin region of the paper by using the printer 20. Then, the printing system 10 sequentially reads the position adjustment images from the preceding printed material by using the image reader 30, and calculates the misalignment information of each of the position adjustment images on the paper on the basis of the read position adjustment images.

Moreover, the printing system 10 calculates a correction value for adjusting the printing position of the print image on the basis of the calculated misalignment information, and adjusts the printing position of the print image to be printed on the paper in the printer 20 on the basis of the calculated correction value. Accordingly, while continuously printing a plurality of printed materials, the misalignment amount of the print image to be printed on paper is reduced.

Here, in the printing system 10 shown in FIG. 3, before the image reader 30 reads the position adjustment image from the printed material of the first page (1p) in the print job, the printer 20 starts the printing of the printed materials of the following second page (2p) and subsequent pages. Therefore, in the printing system 10 shown in FIG. 3, the printing position of the print image is not adjusted during the printing of the printed materials of the first to fourth pages (1 to 4p), and the printing position of the print image is adjusted from the printed materials of the fifth page (5p) and subsequent pages.

In addition, FIG. 4 shows a graph indicating the relationship between the number of printed sheets of the printed material and the misalignment amount of the position adjustment image read from the printed material by the image reader 30 in the printing system 10 shown in FIG. 3. The misalignment amount (misalignment information) of the position adjustment image is, for example, the misalignment amount (registration position) of the position adjustment image in the transport direction of the paper.

As shown in FIG. 4, in the printed materials of the first to fourth pages (1 to 4p) where the printing position of the print image is not adjusted, the amount of misalignment of the position adjustment image is large, and in the printed materials of the fifth page (5p) and subsequent pages where the printing position of the print image is adjusted, the amount of misalignment of the position adjustment image is small.

In a case where printing of subsequent printed material is started before the position adjustment image is read from the preceding printed material as described above, a plurality of printed materials in which the printing position of the print image is not adjusted are generated.

### Measures Against Variation in Misalignment Information

Here, in order to reduce the variation in the misalignment information of the print image, it is considered to calculate a moving average value of the plurality of pieces of misalignment information and calculate a correction value for the printing position of the print image on the basis of the calculated moving average value.

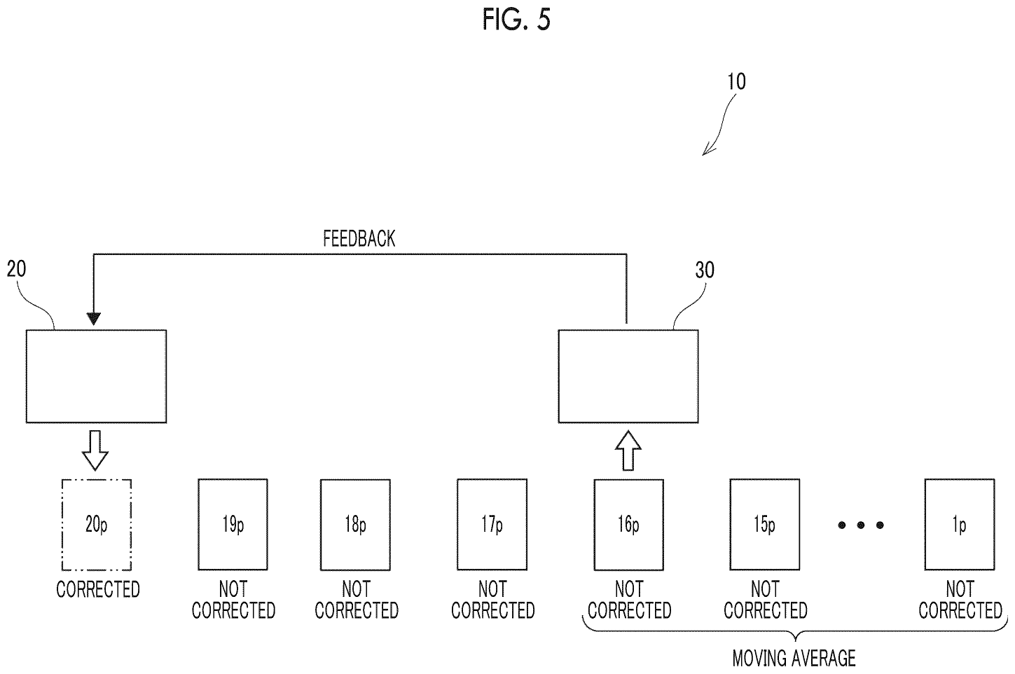

Specifically, in the printing system 10 shown in FIG. 5, the misalignment information of the position adjustment image is set as a moving average value of 16 printed materials. In this case, in the image reader 30, in a case where the number of times of reading the position adjustment image from the printed material (hereinafter referred to as “the number of times of reading”) does not reach the number of times required for calculating the moving average of the misalignment information, that is, 16, the misalignment information is not calculated, and in the printer 20, the printing position of the print image is not adjusted.

In addition, in the printing system 10 shown in FIG. 5, printing of printed materials of the following the 17th page (17p) and subsequent pages is started in the printer 20 before the correction value is calculated. Therefore, in the printing system 10 shown in FIG. 5, the printing position of the print image is not adjusted during the printing of the printed materials of the first to 19th pages (1 to 19p), and the printing position of the print image is adjusted from the printed materials of the 20th page (20p) and subsequent pages.

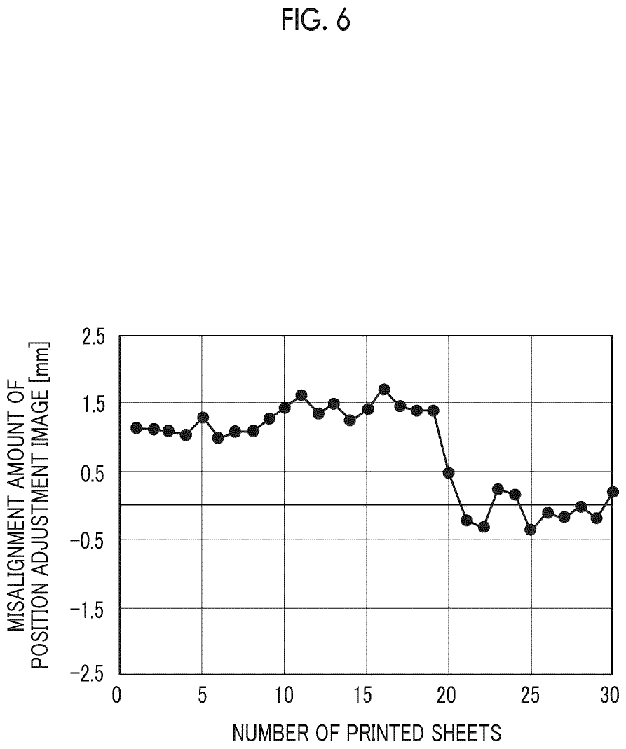

In addition, FIG. 6 shows a graph indicating the relationship between the number of printed sheets of the printed material and the misalignment amount of the position adjustment image read from the printed material by the image reader 30 in the printing system 10 shown in FIG. 5. The misalignment amount (misalignment information) of the position adjustment image is, for example, the misalignment amount (registration position) of the position adjustment image in the transport direction of the paper.

As shown in FIG. 6, in the printed materials of the first to 19th pages (1 to 19p) where the printing position of the print image is not adjusted, the amount of misalignment of the position adjustment image is large, and in the printed materials of the 20th page (20p) and subsequent pages where the printing position of the print image is adjusted, the amount of misalignment of the position adjustment image is small.

In this way, in a case where the moving average value of the plurality of pieces of misalignment information is calculated and the correction value for the printing position of the print image is calculated on the basis of the calculated moving average value, the number of printed materials in which the printing position of the print image is not adjusted increases.

Therefore, in the printing system 10 according to the present exemplary embodiment, the printing positions of a minimum number of pages for which printing positions are adjustable, among second and subsequent pages in the print job, are adjusted on the basis of the position adjustment image of the first page in the print job. Hereinafter, the printing system 10 according to the present exemplary embodiment will be described in detail.

### Hardware Configuration of Printing Device

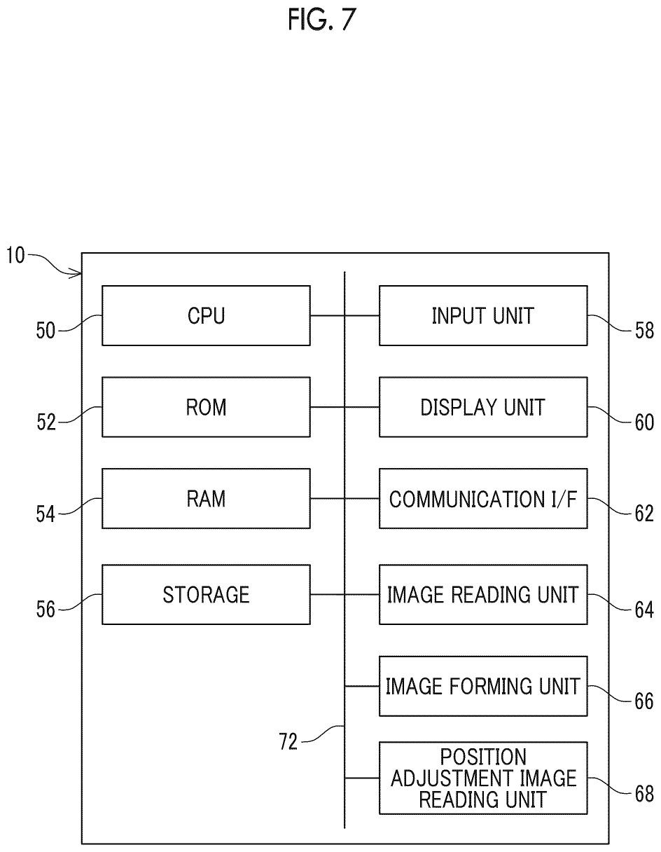

First, the hardware configuration of the printing system 10 will be described. It should be noted that, in the following, for convenience of description, a hardware configuration of the printing system 10 will be described, but the printer 20 and the image reader 30 may separately include the hardware configuration as shown in FIG. 7.

As shown in FIG. 7, the printing system 10 has components including a central processing unit (CPU) 50, a read only memory (ROM) 52, a random access memory (RAM) 54, a storage 56, an input unit 58, a display unit 60, a communication interface (I/F) 62, an image reading unit 64, an image forming unit 66, and a position adjustment image reading unit 68. The configurations are connected to each other via a bus 72 in a communicable manner.

The CPU 50 is a central processing unit and executes various programs or controls each unit. That is, the CPU 50 reads out a program from the ROM 52 or the storage 56 and executes the program using the RAM 54 as a work area. The CPU 50 controls each of the above-described configurations and performs various types of arithmetic process according to the program recorded on the ROM 52 or the storage 56. The CPU 50 is an example of an adjustment unit and a processor.

The ROM 52 stores various information processing programs and various types of data. The RAM 54 temporarily stores the program or the data as the work area of the CPU 50.

The storage 56 is configured with a hard disk drive (HDD) or a solid state drive (SSD), and stores various programs including an operating system and various types of data.

The input unit 58 includes an operation button or the like and is used to perform various inputs. The display unit 60 is, for example, a liquid crystal display and displays various types of information. The display unit 60 may be a touch panel type and may function as the input unit.

The communication I/F 62 is an interface for communication with other apparatuses. For example, a standard, such as Ethernet (Registered Trademark), FDDI, or Wi-Fi (Registered Trademark), is used.

The image reading unit 64 includes a scanner or the like and optically reads image data from a document or the like. The image forming unit 66 prints the image data read by the image reading unit 64 or the image data received from an operation terminal (not shown) on a recording medium such as paper.

The position adjustment image reading unit 68 includes a scanner or the like, and optically reads, for example, the print image, such as the position adjustment image, from the paper (printed material) on which the image forming unit 66 has printed the image.

### Function of Printing Device

Next, the functions of the printing system 10 will be described.

In a case where the information processing program described above is executed, the printing system 10 implements various functions of the printer 20 and the image reader 30 by using the above hardware resources.

### Printer

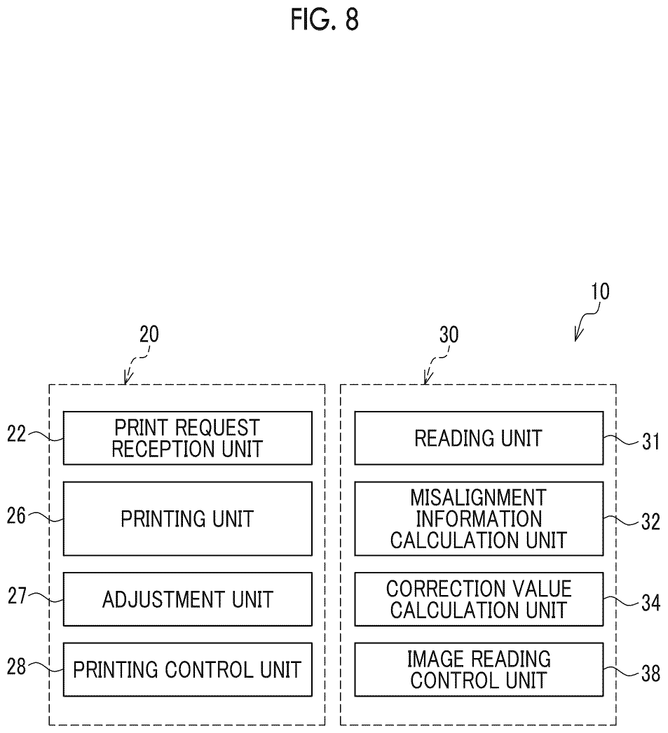

Specifically, as shown in FIG. 8, the printer 20 functionally includes a print request reception unit 22, a printing unit 26, an adjustment unit 27, and a printing control unit 28.

### Print Request Reception Unit

The print request reception unit 22 receives the print job of the correction continuous print input to the printing system 10. This print job includes, for example, information (print data) about a print image and printing conditions such as paper size and the number of printed sheets of paper.

### Printing Unit

The printing unit 26 prints a print image (including a position adjustment image) on the paper on the basis of the print request for the correction continuous printing received by the print request reception unit 22. In this case, the printing unit 26 adjusts the position of the print image to be printed on the paper on the basis of the correction value of the printing position of the print image calculated by the correction value calculation unit 34 described below.

### Adjustment Unit

The adjustment unit 27 adjusts the printing position of the print image to be printed on the paper on the basis of the correction value of the printing position of the print image calculated by the correction value calculation unit 34 described below.

### Printing Control Unit

The printing control unit 28 controls the overall operation of the printer 20. In addition, the printing control unit 28 continuously prints a plurality of printed materials while adjusting the printing position of the print image to be printed on the paper on the basis of the print job received by the print request reception unit 22.

Specifically, the printing control unit 28 controls a paper feeding device (not shown) on the basis of the print job received by the print request reception unit 22 to sequentially supply a plurality of sheets of paper from the accommodation tray 20T to the printing unit 26. In addition, the printing control unit 28 transmits the print data to be printed on the plurality of sheets of paper to the printing unit 26. Then, the printing control unit 28 causes the printing unit 26 to print the print image and the position adjustment image based on the print data on the plurality of sheets of paper supplied from the accommodation tray 20T, and sequentially supplies the plurality of printed materials from the printing unit 26 to the image reader 30.

### Image Reader

The image reader 30 functionally includes a reading unit 31, a misalignment information calculation unit 32, a correction value calculation unit 34, and an image reading control unit 38.

### Reading Unit

The reading unit 31 optically reads the position adjustment image from the printed material printed by the printing unit 26.

### Misalignment Information Calculation Unit

The misalignment information calculation unit 32 calculates the detection position of the position adjustment image by performing the image process on the position adjustment image read by the reading unit 31. The misalignment information calculation unit 32 calculates the misalignment information of the position adjustment image on the basis of the calculated detection position of the position adjustment image and the target position.

Examples of the misalignment information of the position adjustment image include the lead position, the side position, the right angle correction amount, the trapezoidal correction amount, and the horizontal magnification, as described above. In addition, the misalignment information of the position adjustment image calculated by the misalignment information calculation unit 32 is stored in a predetermined storage region as time-series data in accordance with the number of sheets of the printed materials.

### Correction Value Calculation Unit

The correction value calculation unit 34 calculates a correction value for the printing position of a print image to be printed on paper on the basis of the misalignment information calculated by the misalignment information calculation unit 32. As described above, the correction value is calculated for each type of misalignment information (lead position, side position, right angle correction amount, trapezoidal correction amount, horizontal magnification, and vertical magnification).

Here, in a case where the number of times of reading the position adjustment image is one, the correction value calculation unit 34 calculates the correction value for the printing position of the print image on the basis of the misalignment information of the first page calculated by the misalignment information calculation unit 32.

In addition, in a case where the number of times of reading the position adjustment image exceeds one and is equal to or smaller than a predetermined upper limit number of times, the correction value calculation unit 34 averages the plurality of pieces of misalignment information in accordance with the number of times of reading the position adjustment image, and calculates the correction value of the printing position of the print image on the basis of the averaged value obtained by the averaging. Examples of the averaging include an arithmetic mean, a geometric mean, a weighted mean, and an exponential mean. In addition, the averaging may include, for example, a process for removing outliers from the section. The upper limit number of times is an integer (upper limit number of times>reference number of times) larger than the reference number of times.

Further, in a case where the number of times of reading the position adjustment image exceeds the upper limit number of times, the correction value calculation unit 34 averages the plurality of pieces of misalignment information in accordance with the upper limit number of times, and calculates the correction value of the printing position of the print image on the basis of the averaged value obtained by the averaging.

Here, for example, in a case where the upper limit number of times is 10, the following occurs. That is, in a case where the number of times of reading the position adjustment image is one, the misalignment information calculation unit 32 calculates the misalignment information on the basis of the position adjustment image read from the printed material of the first page by the image reader 30.

Then, the correction value calculation unit 34 calculates the correction value for the printing position of the print image on the basis of the misalignment information of the first page calculated by the misalignment information calculation unit 32.

Next, in a case where the number of times of reading the position adjustment image is two, the misalignment information calculation unit 32 calculates the misalignment information on the basis of the position adjustment image read from the printed material of the second page by the image reader 30. Then, the correction value calculation unit 34 averages the misalignment information of the first and second pages calculated by the misalignment information calculation unit 32, and calculates the correction value for the printing position of the print image on the basis of the averaged value obtained by the averaging.

Next, in a case where the number of times of reading the position adjustment image is three, the misalignment information calculation unit 32 calculates the misalignment information on the basis of the position adjustment image read from the printed material of the third page by the image reader 30. Then, the correction value calculation unit 34 averages the misalignment information of the first to third pages calculated by the misalignment information calculation unit 32, and calculates the correction value for the printing position of the print image on the basis of the averaged value obtained by the averaging.

In addition, in a case where the number of times of reading the position adjustment image is from 2 to 10, the correction value calculation unit 34 averages the plurality of pieces of misalignment information while increasing the number of sections in accordance with the number of times of reading the position adjustment image, and calculates the correction value of the printing position of the print image on the basis of the averaged value obtained by the averaging.

Next, in a case where the number of times of reading the position adjustment image is 11, that is, in a case where the number of times of reading the position adjustment image exceeds the upper limit number of times, the correction value calculation unit 34 averages the plurality of pieces of misalignment information in accordance with the upper limit number of times. More specifically, the correction value calculation unit 34 averages (performs moving averaging process on) the plurality of pieces of misalignment information, with the number of sections as 10 which is the upper limit number of times. In other words, the correction value calculation unit 34 averages a plurality of pieces of misalignment information from the latest to the number of times corresponding to the upper limit number of times, among the plurality of pieces of misalignment information calculated by the misalignment information calculation unit 32.

The upper limit number of times can be appropriately changed and may be set to, for example, two or more and nine or fewer, or may be set to 11 or more.

In addition, in a case where the plurality of pieces of misalignment information are averaged, the number of times of reading the position adjustment image and the number of sections in the averaging do not necessarily need to match. For example, in a case where the number of times of reading the position adjustment image is four, the number of sections in the averaging may be three.

### Image Reading Control Unit

The image reading control unit 38 controls the overall operation of the image reader 30. Specifically, the image reading control unit 38 causes the reading unit 31 to read the position adjustment image from the printed material and causes the misalignment information calculation unit 32 to calculate the position misalignment information of the position adjustment image.

Further, the image reading control unit 38 causes the correction value calculation unit 34 to calculate the correction value for the printing position of the print image to be printed on the paper by the printer 20. Then, the image reading control unit 38 transmits the correction value calculated by the correction value calculation unit 34 to the printing control unit 28.

The printing control unit 28 and the image reading control unit 38 transmit and receive information to and from each other, thereby cooperating to control the overall operation of the printing system 10.

### Correction Value Calculation Process of Printing Device

Next, the correction value calculation process by the printing system 10 will be described.

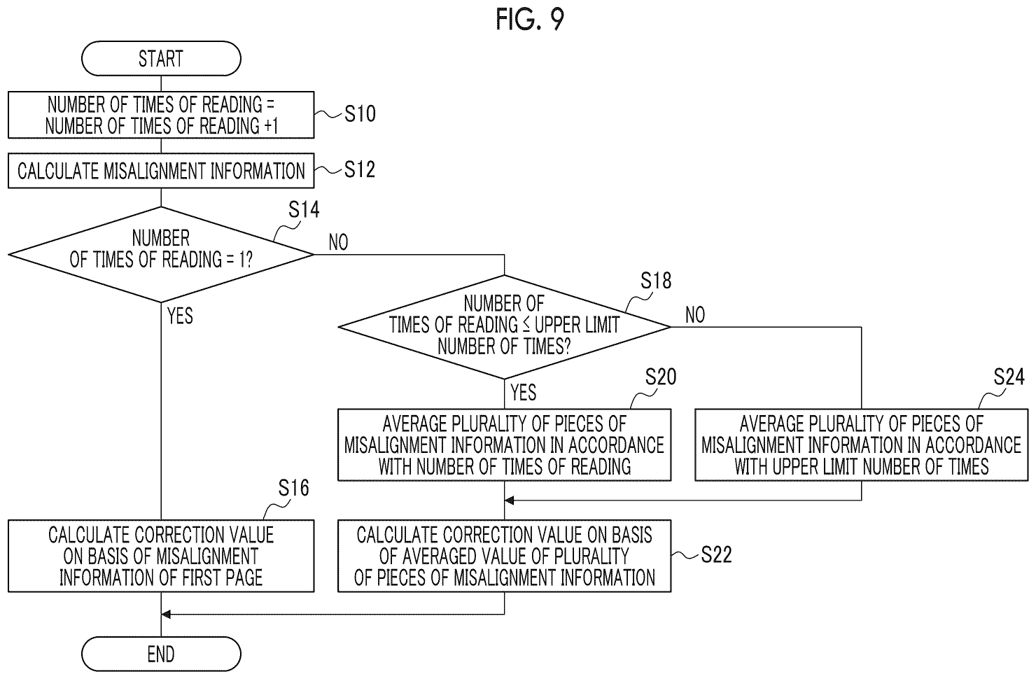

In the printing system 10, in a case where a print job is executed and the position adjustment image is read from the printed material by the image reader 30, the correction value calculation process shown in FIG. 9 is executed. The correction value calculation process is an example of a correction value calculation method.

First, in step S10, the CPU 50 adds 1 to the number of times of reading the position adjustment image as a variable. The number of times of reading the position adjustment image as a variable is initialized (the number of times of reading=0) when the correction continuous printing process is executed.

Next, in step S12, the CPU 50 calculates the misalignment information of the position adjustment image on the basis of the position adjustment image read from the printed material by the image reader 30.

Next, in step S14, the CPU 50 determines whether or not the number of times of reading the position adjustment image is one. In a case where the CPU 50 determines that the number of times of reading the position adjustment image is one, the CPU 50 transitions to step S16.

Next, in step S16, the CPU 50 calculates the correction value for the printing position of the print image on the basis of the misalignment information of the first page calculated in step S14, and ends the correction value calculation process.

Here, in a case where the correction value is calculated, the CPU 50 adjusts the printing position of the print image to be printed next on the paper on the basis of the calculated correction value. Specifically, the CPU 50 adjusts the printing position of the image on the basis of the correction value calculated in step S16 in the page in the print job printed after the calculation of the correction value of the printing position of the print image. In other words, the CPU 50 adjusts printing positions of a minimum number of pages for which printing positions are adjustable, among second and subsequent pages in the print job, on the basis of the position adjustment image of the first page in the print job. In the example shown in FIG. 3, the CPU 50 adjusts the printing position of the fifth page (5p) of the print job on the basis of the position adjustment image of the first page (1p) of the print job.

On the other hand, in step S14, in a case where the CPU 50 determines that the number of times of reading the position adjustment image exceeds one, the CPU 50 transitions to step S18.

Next, in step S18, the CPU 50 determines whether or not the number of times of reading the position adjustment image is less than or equal to the upper limit number of times. In a case where the CPU 50 determines that the number of times of reading the position adjustment image is equal to or smaller than the upper limit number of times, the CPU 50 transitions to step S20.

Next, in step S20, the CPU 50 averages the plurality of pieces of misalignment information in accordance with the number of times of reading the position adjustment image, and calculates an averaged value. Specifically, the CPU 50 averages the plurality of pieces of misalignment information calculated on the basis of the position adjustment image read from the first time to the number of times of reading, and calculates an averaged value.

Next, in step S22, the CPU 50 calculates the correction value for the printing position of the print image to be printed on the paper on the basis of the averaged value of the plurality of pieces of misalignment information, and ends the correction value calculation process.

Here, in a case where the correction value is calculated, the CPU 50 adjusts the printing position of the print image to be printed next on the paper on the basis of the calculated correction value. Specifically, the CPU 50 adjusts the printing position of the print image to be printed on paper, in the pages in the print job to be printed after the calculation of the correction value, on the basis of the correction value calculated in step S22.

On the other hand, in step S18, in a case where the CPU 50 determines that the number of times of reading the position adjustment image exceeds the upper limit number of times, the CPU 50 transitions to step S24.

Next, in step S24, the CPU 50 averages the plurality of pieces of misalignment information in accordance with the upper limit number of times of the number of times of reading the position adjustment image, and calculates an averaged value. Specifically, the CPU 50 calculates an averaged value by averaging the plurality of pieces of misalignment information from the latest to the upper limit number of times, among the plurality of pieces of misalignment information. The CPU 50 transitions to the above-described step S22.

### Feedback Control

Here, feedback control of the printing position of a print image to be printed on paper in the printer 20 will be described.

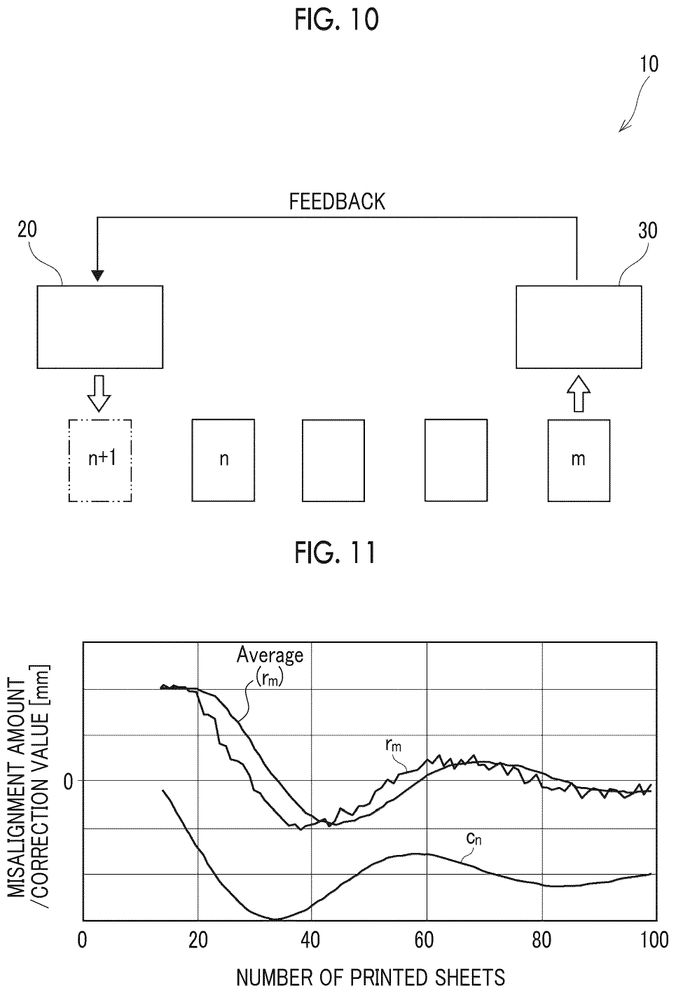

As shown in FIG. 10, in a case where the misalignment amount calculated on the basis of the position adjustment image read from the printed material (the number of times of reading: m) of the m-th page is defined as rₘ, and a correction value of a printing position of a print image applied during the printing of the printed material of the n-th page (n>m) is defined as Cₙ, an update expression of a general correction value Cₙ₊₁ using the moving average is as shown in Equation (1).

$${C}_{n + 1} = - G \times Average ( {r}_{m} ) + {C}_{n} \qquad ( 1 )$$

where,
G: Gain (0<G≤1)
Average (rₘ): Z-sheet moving average value of misalignment amount rₘ (Z: number of sections (average number of sheets))

In addition, to supplement the method of deriving the above-described Equation (1), a general update expression of the feedback control is given by Equation (2).

$${C}_{n + 1} = Δ C + {C}_{n} \qquad ( 2 )$$

In Equation (2), the second term on the right side is the latest correction value Cₙ, and the first term on the right side is the correction value ΔC that cannot be adjusted by the correction value Cₙ. In a case where the correction value ΔC is simplified and regarded as the negative misalignment amount rₘ, Equation (3) is obtained.

$${C}_{n + 1} = - {r}_{m} + {C}_{n} \qquad ( 3 )$$

In Equation, in order to reduce the noise of the misalignment amount rₘ, a moving average (the number Z of sections) of the misalignment amount rₘ is obtained. In addition, since a phase difference occurs between the first term and the second term on the right side, the above Equation (1) is derived by multiplying the first term by the gain G for stabilization.

FIG. 11 shows graphs rₘ, Average (rₘ), and Cₙ indicating the relationship between the number of printed sheets of the printed material and the misalignment amount or the correction value for the misalignment amount rₘ, the moving average value Average (rₘ) of the misalignment amount, and the correction value Cₙ. In FIG. 11, the number Z of sections of the moving average value Average (rₘ) of the misalignment amount rₘ is set to 10 (Z=10). In addition, in FIG. 11, the gain G is set to 0.1 (G=0.1).

As shown in FIG. 11, it can be seen that the misalignment amount rₘ converges to a value near 0 with an increase in the number of printed sheets. However, in Equation (1), in a case where the number of printed sheets is small, an error in the correction value C₁₊₁ is likely to be large due to a difference caused by a phase difference and the like between the latest correction value Cₙ applied to the printed material of the n-th page and the misalignment amount rₘ based on the printed material of the m-th page.

Therefore, Equation (1) is modified to following Equation (4). Specifically, in Equation (4), the correction value Cₙ₊₁ is calculated on the basis of the difference between the latest correction value Cₘ applied to the printed material of the m-th page, instead of the correction value Cₙ applied to the printed material of the n-th page, and the misalignment amount rₘ on the basis of the printed material of the m-th page. Accordingly, since the difference due to the phase difference or the like between the first term and the second term on the right side of Equation (4) is reduced, the error of the correction value Cₙ₊₁ is smaller as compared to Equation (1).

$${C}_{n + 1} = G \times ( - Average ( {r}_{m} - {C}_{m} ) - {C}_{n} ) + {C}_{n} \qquad ( 4 )$$

In addition, since the difference between the first and second terms on the right side of Equation (4) becomes small, the gain G (G=1) may be omitted as in Equation (5).

$${C}_{n + 1} = - Average ( {r}_{m} - {C}_{m} ) \qquad ( 5 )$$

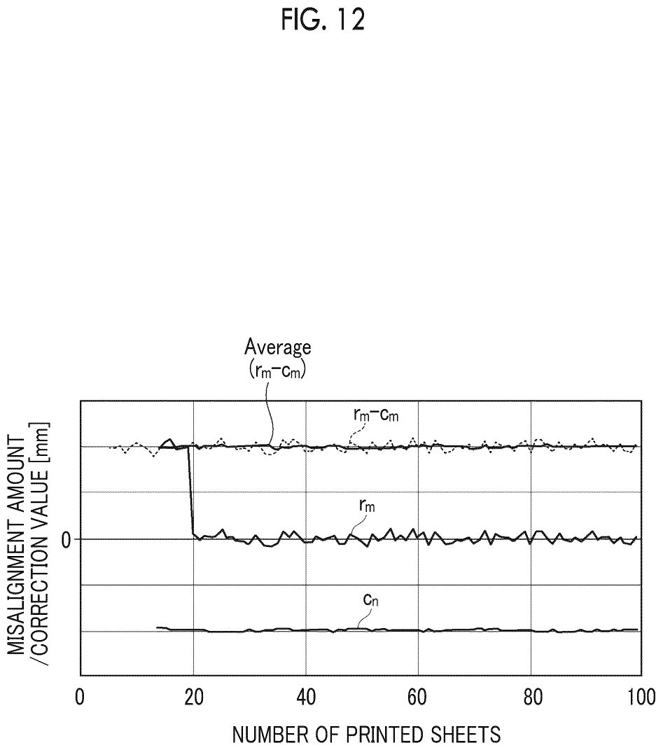

FIG. 12 shows graphs rₘ, rₘ-Cₘ, Average (rₘ-Cₘ), and Cₙ indicating the relationship between the number of printed sheets of the printed material and the misalignment amount or the correction value for the misalignment amount rₘ, the misalignment amount (rₘ-Cₘ), the moving average value Average (rₘ-Cₘ) of the misalignment amount, and the correction value C₁ in Equation (5). In FIG. 12, the number Z of sections of the moving average value Average (rₘ-Cₘ) of the misalignment amount (rₘ-Cₘ) is set to 10 (Z=10).

As shown in FIG. 12, it can be seen that the misalignment amount rₘ converges to 0 with an increase in the number of printed sheets. In addition, the graph rₘ of the misalignment amount rₘ of Equation (5) has a smaller amplitude of vibration and converges to near 0 from a smaller number of printed sheets, as compared with the graph rₘ of the misalignment amount rₘ of Equation (1) (see FIG. 11).

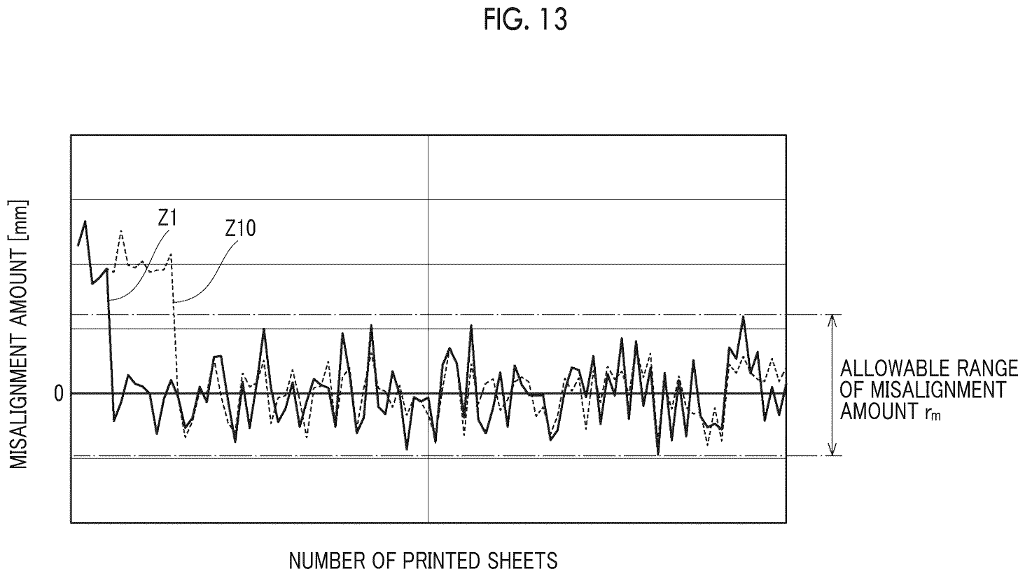

In addition, FIG. 13 shows graphs Z1 and Z10 indicating the relationship between the number of printed sheets of the printed material and the misalignment amount rₘ for cases where the number Z of sections of the moving average value Average (rₘ-Cₘ) is 1 and 10. The allowable range of the misalignment amount is appropriately set in accordance with, for example, the printing quality of the printed material.

As shown in FIG. 13, in graph Z1, the variation in misalignment amount rₘ is slightly larger than that in graph Z10, but falls within the allowable range of the misalignment amount rₘ. In addition, in graph Z1, the misalignment amount rₘ converges, from a smaller number of printed sheets of the printed material as compared to the graph Z10. That is, in graph Z1, the number of printed materials where the printing position of the print image is not adjusted is smaller than in graph Z10.

From the above, it is preferable that the number Z of sections of the moving average value of the misalignment amount is small when the printing of the printed material is started, and is increased as the number of printed sheets of the printed material increases, for example. Accordingly, the misalignment of the print image on the printed material is suppressed, and the number of printed materials in which the printing position of the print image is not adjusted is reduced.

In the printing system 10 according to the exemplary embodiment, any of Equation (1), Equation (4), and Equation (5) can be used. In addition, in the printing system 10 according to the exemplary embodiment, other expressions may be used instead of Equation (1), Equation (4), Equation (5), and the like.

### Modification Example

Next, modification examples of the above-described exemplary embodiment will be described.

In the above exemplary embodiment, in a case where the number of times of reading the position adjustment image exceeds one and is less than or equal to the upper limit number of times, the plurality of pieces of misalignment information are averaged in accordance with the number of times of reading. However, in a case where the number of times of reading the position adjustment image exceeds one, the plurality of pieces of misalignment information may not be subjected to the averaged in accordance with the number of times of reading, and the correction value may be calculated on the basis of the latest misalignment information.

In addition, in the above-described exemplary embodiment, in a case where the number of times of reading the position adjustment image exceeds the upper limit number of times, the plurality of pieces of misalignment information is averaged in accordance with the upper limit number of times. However, the upper limit number of times may be omitted. In this case, for example, the plurality of pieces of misalignment information may be averaged in accordance with the number of times of reading the position adjustment image, or the correction value may be calculated on the basis of the latest misalignment information without averaging the plurality of pieces of misalignment information.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

In the above exemplary embodiment, the form in which each program is installed in the ROM or the storage has been described, but the present invention is not limited thereto. Each program according to the above exemplary embodiment may be provided in the form of a recording on a computer readable storage medium. For example, each program according to the above exemplary embodiment may be provided in the form of a recording on an optical disc such as a compact disc (CD)-ROM and a digital versatile disc (DVD)-ROM or in the form of a recording on a semiconductor memory such as a universal serial bus (USB) memory and a memory card. Further, each program according to the above-described exemplary embodiment may be acquired from an external apparatus via a communication I/F.

In addition, in the exemplary embodiment described above, a case where the processing in the printing system 10 is implemented by a software configuration by using a computer by executing a program is described, but the present disclosure is not limited thereto. For example, the processing in the printing system 10 may be implemented by a hardware configuration or a combination of the hardware configuration and the software configuration.

Further, needless to say, the configuration of the printing system 10 described in the exemplary embodiment described above is an example, and an unnecessary part may be deleted or a new part may be added without departing from the gist of the present disclosure.

In addition, needless to say, the flow of the processes in the printing system 10 described in the above exemplary embodiment is also an example, and an unnecessary step may be deleted, a new step may be added, or processing order may be changed without departing from the gist of the present disclosure.

The following supplementary notes are further disclosed regarding the above-described exemplary embodiment.

(((1)))

A printing system comprising:
a printing unit that prints a print job and prints a position adjustment image corresponding to each page in the print job;
a reading unit that reads the position adjustment image printed by the printing unit; and
an adjustment unit that adjusts a printing position of each page in the print job to be printed by the printing unit on the basis of the position adjustment image read by the reading unit,
wherein the adjustment unit adjusts printing positions of a minimum number of pages for which printing positions are adjustable, among second and subsequent pages in the print job, on the basis of a position adjustment image of a first page in the print job.

(((2)))

The printing system according to (((1))),
wherein the adjustment unit adjusts, on the basis of a correction value adjusted using the read position adjustment image, a printing position of a page to be printed after the correction value is adjusted, each time the position adjustment image of the second and subsequent pages in the print job is read.

(((3)))

The printing system according to (((2))),
wherein the adjustment unit calculates misalignment information of the position adjustment image for each page on the basis of the position adjustment image, and adjusts the printing position of the page on the basis of an averaged value obtained by averaging the calculated misalignment information in accordance with the number of times of reading the position adjustment image.

(((4)))

The printing system according to (((3))),
wherein the adjustment unit averages the misalignment information in accordance with a predetermined upper limit number of times, in a case where the number of times of reading exceeds the upper limit number of times.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A printing system comprising:
a printing unit that prints a print job and prints a position adjustment image corresponding to each page in the print job;
a reading unit that reads the position adjustment image printed by the printing unit; and
an adjustment unit that adjusts a printing position of each page in the print job to be printed by the printing unit on the basis of the position adjustment image read by the reading unit, and adjusts printing positions of a minimum number of pages for which printing positions are adjustable, among second and subsequent pages in the print job, on the basis of a position adjustment image of a first page in the print job.

2. The printing system according to claim 1,
wherein the adjustment unit adjusts, on the basis of a correction value adjusted using the read position adjustment image, a printing position of a page to be printed after the correction value is adjusted, each time the position adjustment image of the second and subsequent pages in the print job is read.

3. The printing system according to claim 2,
wherein the adjustment unit calculates misalignment information of the position adjustment image for each page on the basis of the position adjustment image, and adjusts the printing position of the page on the basis of an averaged value obtained by averaging the calculated misalignment information in accordance with the number of times of reading the position adjustment image.

4. The printing system according to claim 3,
wherein the adjustment unit averages the misalignment information in accordance with a predetermined upper limit number of times, in a case where the number of times of reading exceeds the upper limit number of times.
